(19) United States
(12) Patent Application Publication
(10) Pub. No.: US 2014/0341441 A1
(43) Pub. Date: Nov. 20, 2014

(54) WEARABLE DEVICE USER AUTHENTICATION

(71) Applicant: MOTOROLA MOBILITY LLC, Libertyville, IL (US)

(72) Inventors: Jiri Slaby, Buffalo Grove, IL (US); Roger W. Ady, Chicago, IL (US)

(21) Appl. No.: 13/928,526

(22) Filed: Jun. 27, 2013

Related U.S. Application Data
(60) Provisional application No. 61/825,213, filed on May 20, 2013.

(51) Int. Cl. G06K 9/00

(52) U.S. Cl. CPC G06K 9/00617; G06K 9/00604; G06K 9/0061
USPC 382/117

(57) ABSTRACT

In embodiments, a wearable device includes an imager that captures eye feature images of one or both eyes of a user of the wearable device, such as while the user is wearing the wearable device. The user can then be authenticated based on a comparison of the eye feature images to a biometric template of the user. The eye feature images may include iris images, retina images, and/or eye vein images of the eyes of the user. The user can be authenticated based on each of the iris images, the retina images, and the eye vein images, both individually and in combination. The imager can also be periodically initiated, to capture the eye feature images to confirm user presence and maintain operability of the wearable device.

### BACKGROUND

Wearable computing devices, such as glasses, are being developed as a communication and visual technology that allow a user to view the environment while also viewing a small display on which images can be projected, such as photos, email and text messages, and documents of any type. For example, a wearable device may communicate with another user device, such as a mobile phone or tablet, device, to access user data, such as the photos, messages, and documents. Glasses that are implemented as a wearable device may also include a camera to capture photos, which are then communicated back to the mobile phone or tablet device. However, without communication security, the data communications between a wearable device and another user device, as well as possibly cloud-based stored user data, may be compromised. Additionally, wearable computing devices are not designed to recognize the associated user-owner of a particular device. If a wearable device is lost or stolen, any person can put on and operate the device with the potential for misuse of the information and data that may be accessed via the device.

### BRIEF DESCRIPTION OF THE DRAWINGS

Embodiments of wearable device user authentication are described with reference to the following Figures. The same numbers may be used throughout to reference like features and components that are shown in the Figures:

FIG. 1 illustrates an example system in which embodiments of wearable device user authentication can be implemented.

FIG. 2 illustrates an example wearable device in which embodiments of wearable device user authentication can be implemented.

FIG. 3 illustrates another example wearable device in which embodiments of wearable device user authentication can be implemented.

FIG. 4 illustrates an example method of wearable device user authentication in accordance with one or more embodiments.

FIG. 5 illustrates another example method of wearable device user authentication in accordance with one or more embodiments.

FIG. 6 illustrates various components of an example electronic device that can implement embodiments of wearable device user authentication.

### DETAILED DESCRIPTION

Embodiments of wearable device user authentication are described, such as for a glasses device that is designed as a wearable computing device and worn by a user. A wearable device may be any type of eye and/or face wearable device that integrates eye verification technology for a natural experience, such as when wearing a glasses device and a user is seamlessly authenticated in the background of other activities and without effort on part of the user. Further, the authentication is continuous or periodic, and the wearable device will lock, or otherwise be rendered inoperable, when it is detected that the user-owner has removed the wearable device. The authentication may be further enhanced by incorporating other information about the user, such as a location of the user, a route, calendar information, and the like. For example, if the current location of the wearable device (and user) is recognized as a likely location of the user, then authentication may be further confirmed.

A wearable device can provide high-fidelity authentication of the wearer, and the user-owner can seamlessly and confidently access financial accounts, conduct point-of-sale transactions, access electronically locked doors, view email and text, messages, arid generally initiate any other types of device functions that may be commonly performed with a mobile computing device, such as a mobile phone or tablet device. In addition, multiple users can use the same wearable device, such as a glasses device, and upon authentication, each user would see his or her personalized interface and content.

In implementations, the glasses device includes one or more imagers to capture eye feature images of a user, and the eye feature images can be used to authenticate the user to the glasses device. For example, if a user loses his or her glasses device, and another person finds and attempts to use them, the device will remain inoperable because user authentication cannot be determined without authentication from eye feature images that correspond to the associated user-owner of the glasses device.

In implementations, the one or more imagers of a glasses device captures the eye feature images of one or both eyes of a user, such as while the user is wearing the glasses device. The eye feature images of the user can be captured as any one or combination of iris images, retina images, and/or eye vein images of the eyes of the user. Additionally, facial features of a user may also be captured, such as when the user is placing the glasses device on his or her face and the one or more imagers of the glasses device capture images of facial features. The user can then be authenticated based on a comparison of the eye feature images and/or the facial features to a biometric template of the user, and in addition, based on comparing the images both individually and in combination. The imager can also be periodically initiated to capture the eye feature images to confirm user presence and maintain operability of the wearable device. The imager can also be periodically used to verify user wellness based on analysis of the eye feature images, and may also be used to determine whether a user is awake, paying attention, focused, and/or for other similar determinations.

A glasses device may include a single imager that is implemented to capture forward-facing images of an environment viewed by the user wearing the wearable device. The imager can also be used to capture the eye feature images with the wearable device held facing towards the eye of the user. As an alternative to the user holding the wearable device to position the imager facing towards the eye of the user, a display lens of the glasses device can be implemented with a prism structure to reflect the eye features of an eye of the user to the imager while the user is wearing the wearable device.

In alternate implementations, a wearable device may include the forward-facing imager as well as another imager that is positioned to capture the eye feature images while the user is wearing the wearable device, such as the glasses device. Additionally, a wearable device may be implemented with multiple imagers to capture the eye feature images of one or both eyes of the user of the wearable device. For example, an imager can capture the eye feature images for a portion of an eye, such as one side of the eye, and an additional imager can capture the eye feature images for another portion of the eye, such as the other side of the eye. Similarly, additional imagers can be implemented to capture the eye feature images of the other eye of the user who wears the wearable device.

A wearable device, such as the glasses device, can also include a light source that illuminates an eye of the user to facilitate capturing the eye feature images with the imager. A light source may be used to illuminate the display lens, which incidentally illuminates an eye of the user when the display lens is illuminated. Alternatively or in addition, an infra-red light source can be used to directly illuminate an eye of the user to facilitate capturing the eye feature images of the eye.

While features and concepts of wearable device user authentication can be implemented in any number of different devices, systems, and/or configurations, embodiments of wearable device user authentication are described in the context of the following example devices, systems, and methods.

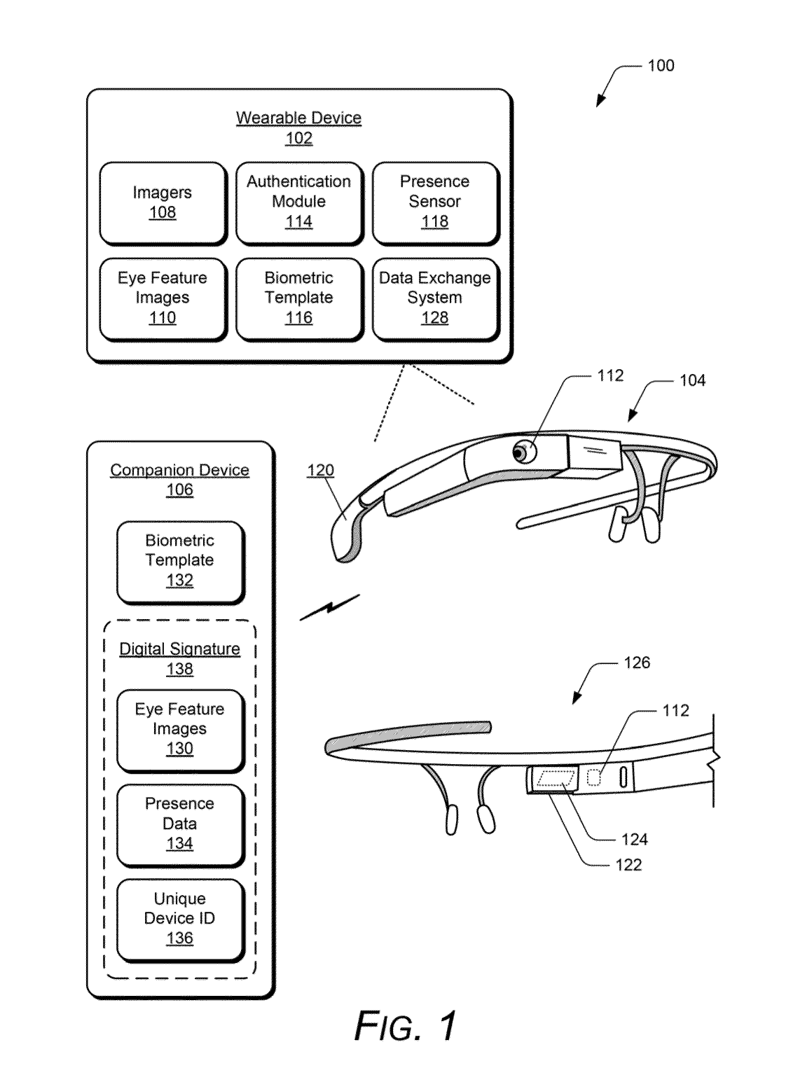

FIG. 1 illustrates an example system 100 in which embodiments of wearable device user authentication can be implemented. The example system 100 includes a wearable device 102, such as a glasses device 104 that a user wears, or any other type of eye and/or face wearable device that integrates eye verification technology for user authentication. The example system also includes a companion device 106, which can be any type of device that is associated to communicate with the wearable device. For example, the companion device 106 may be any type of portable electronic and/or computing device, such as a mobile phone, tablet computer, handheld navigation device, portable gaming device, media playback device, and/or any other type of electronic and/or computing device.

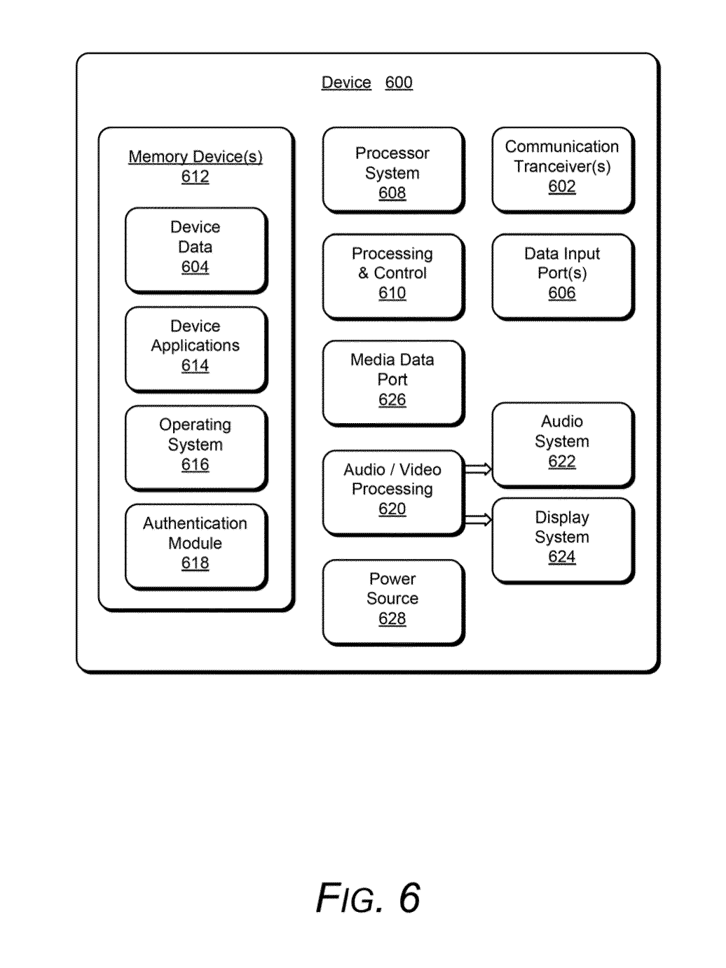

Additionally, the wearable device 102, such as glasses device 104, and/or the companion device 106 can be implemented with various components, such as a processing system, and memory, as well as any number and combination of differing components as further described with reference to the example device shown in FIG. 6. For example, the glasses device 104 can include a power source (not shown) to power the device, such as a flexible strip battery, a rechargeable battery, and/or any other type of active or passive power source that may be implemented in a wearable device. The glasses device 104 may also be implemented to utilize RFXD, NFC, Bluetooth™, and/or Bluetooth™ low energy (BTLE).

The example wearable device 102 includes one or more imagers 108 that are implemented to capture eye feature images 110 of one or both eyes of a user of the wearable device. The eye feature images of an eye can be captured as any one or combination of iris images, retina images, and/or eye vein images of the eyes of the user. Additionally, facial features of the user may also be captured, such as when the user is placing the glasses device on his or her face and the one or more imagers of the glasses device capture images of facial features. For example, the glasses device 104 has an imager 112 that is implemented to capture forward-facing images of an environment viewed by the user wearing the glasses device. The imager 112 can also be used to capture the eye feature images 110 with the glasses device held lacing towards the eye of the user, such as when the user takes the glasses device off and holds it to position the imager 112 lacing an eye of the user to capture the eye feature images. Alternatively, a flip-down mirror may be implemented to facilitate capturing the eye feature images via the single imager 112 for authentication, of the user.

The example wearable device 102 includes an authentication module 114 that can be implemented as a software application (e.g., executable instructions) stored on computer-readable storage media, such as any suitable memory device or electronic data storage. The wearable device 102 can be implemented with computer-readable storage media as described with reference to the example device shown in FIG. 6. The authentication module 114 is implemented to authenticate the user based on a comparison of the eye feature images 110 to a biometric template 116 of the user, and the images can be compared for authentication both individually and in combination. The authentication module can also periodically initiate the one or more imagers 108 to capture the eye feature images of an eye of the user to confirm user presence and maintain operability of the wearable device. The authentication module can also be implemented to use likely user location information, user route information, and/or calendar information to further authenticate the user of the wearable device. For example, if the current location of the wearable device is recognized as a likely location of the user, is a location along a likely route of the user, or is a location identified in a calendar appointment, then authentication may be further confirmed.

The biometric template 116 of the user can include control images for comparison, such as previous iris, retina, and/or eye vein images of the eyes of the user. Additionally, the control images of the biometric template can include facial feature images, such as any type of identifiable and/or measurable facial recognition features of a user. The biometric template may also include other information about a user, such as to determine wellness changes of the user after the biometric template is created. In implementations, the example wearable device 102 includes a presence sensor 118 that periodically detects a presence of the user wearing the wearable device. For example, the glasses device 104 can include a presence sensor integrated inside of the frame 120 of the glasses as a capacitive sensor that detects user presence based on continued contact with the glasses while the user is wearing the glasses device. Alternatively or in addition, the glasses device can include ultrasonic and/or infra-red (IR) sensors that periodically detects a biometric indication of user presence with penetrating high frequency sound waves over the ear of the user, such as to detect a heart rate of the user who is wearing the glasses.

As an alternative to a user holding the glasses device 104 to position the imager 112 lacing towards the eye of the user to capture the eye feature images 310, a display lens 122 of the glasses device can be implemented with a prism structure 124 to reflect the eye features of an eye of the user to the imager 112 while the user is wearing the glasses device (as shown at 126). The prism, structure can be implemented based on prism and wedge display technologies, such as with a wedge lens that reflects the eye features of the eye to the imager. A user can still see through or around the display lens 122 of the glasses device to view the environment, and also see images that are displayed on the display lens, such as any type of documents, photos, email and text messages, video, graphics, and the like.

The glasses device 104 may also include an internal light source that is implemented to illuminate the display lens 122, and incidentally illuminates an eye of the user when the display lens is illuminated, which facilitates capturing the eye feature images 110 of the eye. This allows authentication even in pitch darkness as soon as the user attempts to view data on the display, or when the authentication module initiates the display to briefly turn on to facilitate authentication.

The wearable device 102 can also include a data exchange system 128 to communicate the eye feature images 110 to the companion device 106 of the wearable device. As an alternative to the wearable device 102 performing user authentication with the authentication module 114, the companion device 106 can compare received eye feature images 130 to a biometric template 132 of a user to authenticate the user. The eye feature images, presence data 134 (as detected, by the presence sensor 118), and a unique device identifier 136 of the wearable device 102 may all be communicated to the companion device 106 for secure storage via any type of secure wireless or wired data transfer and/or storage methods that utilize encryption and/or secure element. Other user and/or device data can also be communicated between the wearable device 102 and the companion device 106, such as any other type of user and/or device identifying features, information, and data. Collectively, the eye feature images 130, the presence data 134, and the unique device identifier 136 is representative of a digital signature 136 of the user and the wearable device 102.

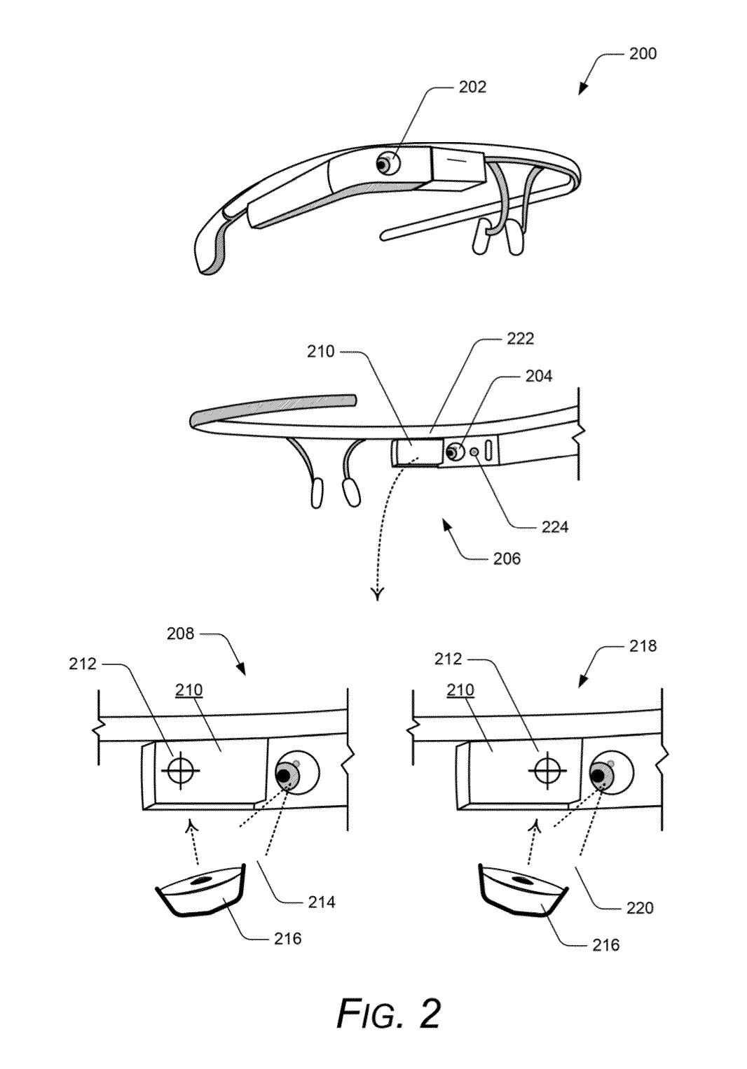

FIG. 2 illustrates another example wearable device implemented as a glasses device 200 in which embodiments of wearable device user authentication can be implemented. The glasses device 200 is an example of the wearable device 102 described with reference to FIG. 1, which can include the authentication module 114 implemented to authenticate a user of the glasses device 200 based on a comparison of eye feature images to a biometric template of the user. The glasses device 200 can also include the imagers 108, the presence sensor 118, and the data exchange system 128 as described with reference to the wearable device 102, along with a processing system and memory, and any number and combination of differing components as further described with reference to the example device shown in FIG. 6.

In this example, the glasses device 200 includes multiple imagers, such as a forward-facing imager 202 that is implemented to capture forward-facing images of an environment viewed by the user wearing the glasses device. The glasses device also includes an additional imager 204 that is designed to capture the eye feature images of an eye of the user while wearing the glasses device. As shown at 206, the additional imager 204 is positioned towards the eye of the user on the inside of the glasses device, and can be implemented as a short distance, fixed-focus or auto-focus imager to capture the eye feature images at the very short distance (e.g., a few centimeters) between the imager and the eye of the user.

In implementations, the imager 204 may only capture the eye feature images of a portion of fee eye of the user who wears the glasses device 200. In some instances, this may provide adequate security for authentication by scanning just one side or a portion of an eye of the user. Alternatively, the imager 204 may be optimized to capture the eye feature images of the whole eye, which may involve the user looking first to one side and then to the other side so that the imager can image both sides of the eye. For example, as shown at 208, this may be accomplished by utilizing the display lens 210 of the glasses device and shifting an image 212, such as a target for instance, that is displayed on the left of the display lens so dial the imager can image at 214 the right side of the eye 216 as the user looks to the left. As shown at 218, the image 212 is then displayed on the right of the display lens 210 so that the imager can image at 220 the left side of the eye 216 as the user looks to the right. Similarly, the target or other image may be displayed on the display lens to position the eye directly towards the imager, such as for iris detection.

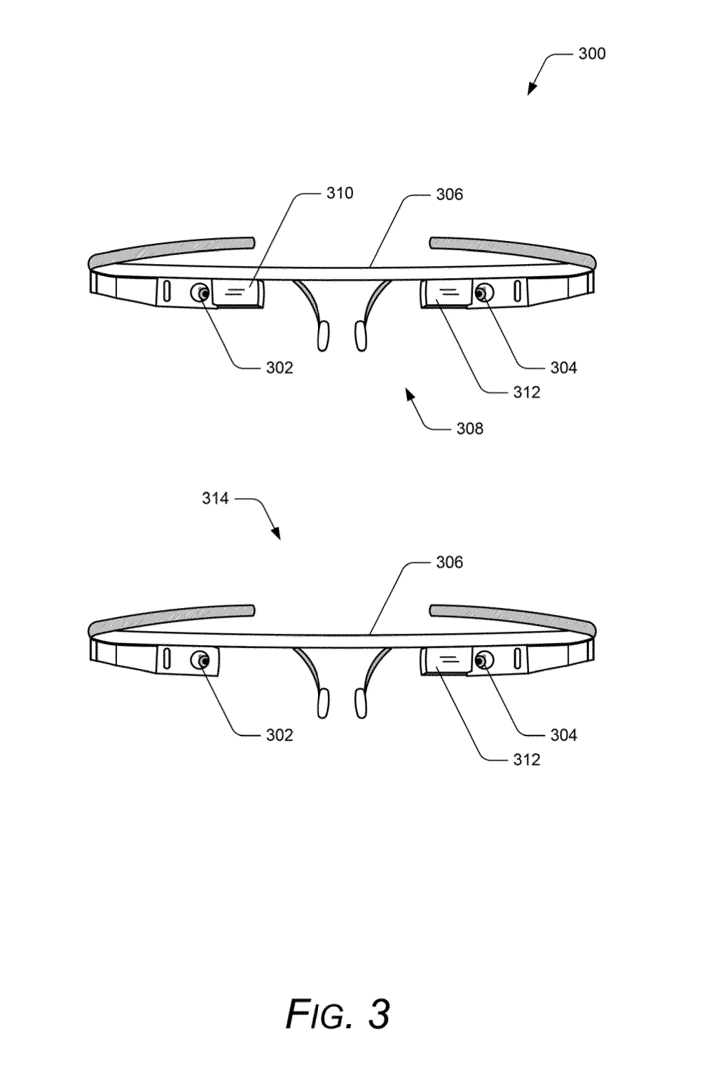

In alternate implementations, multiple internal-facing imagers can be implemented, such as integrated into the frame 222 or attached to the frame of the glasses device 200. Examples of a glasses device with multiple internal-facing imagers is shown in FIG. 3. The imager 204 can then capture the eye feature images of a portion of the eye of the user who wears the glasses device 200, and an additional internal-facing imager can be used to capture the eye feature images of a different portion of the eye of the user, in implementations, two imagers can be utilized to capture the eye feature images of one eye of the user, or four imagers can be utilized to capture the eye feature images of both sides of the left and right eyes of the user. In this configuration, a glasses device may include a display lens and one or two imagers on each side of the glasses, either as a component or system attached to the frame of the glasses device, or integrated into the frame of the glasses device.

The glasses device 200 can also include an infra-red light source 224 that is implemented to illuminate the eye of the user, which facilitates capturing the eye feature images of the eye. The infra-red light source can be positioned to directly illuminate an eye of the user, or may be utilized to illuminate the display lens 210, which incidentally illuminates the eye of the user when the display lens is illuminated to allow authentication even in pitch darkness.

FIG. 3 illustrates another example wearable device implemented as a glasses device 300 in which embodiments of wearable device user authentication can be implemented. The glasses device 300 is an example of the wearable device 102 described with reference to FIG. 1, which can include the authentication module 114 implemented to authenticate a user of the glasses device 300 based on a comparison of eye feature images to a biometric template of the user. The glasses device 300 can also include the imagers 108, the presence sensor 118, and the data exchange system 128 as described with reference to the wearable device 102, along with a processing system and memory, and any number and combination of differing components as further described with reference to the example device shown in FIG. 6.

In this example, the glasses device 300 includes multiple internal-facing imagers 302 and 304, such as integrated into the frame 306 or attached to the frame of the glasses device. As described above, each of the imagers are utilized to capture the eye feature images of the left and right eyes of a user who wears the glasses device. For example, the imager 302 can capture the eye feature images of the left eye of the user (or one or more portions of the left eye of the user), and the imager 304 can capture the eye feature images of the right eye of the user (or one or more portions of the right eye of the user). As shown at 308, a configuration of the glasses device 300 may also include multiple display lenses, such as display lens 310 on one side of the glasses for viewing with the left eye of the user, and display lens 312 on the other side of the glasses for viewing with the right eye of the user. Alternatively, as shown at 314, a configuration of the glasses device 300 may include just the one display lens 312 for viewing with the right eye of the user, while the imager 302 is still utilized to capture the eye feature images of the left eye of the user who wears the glasses device.

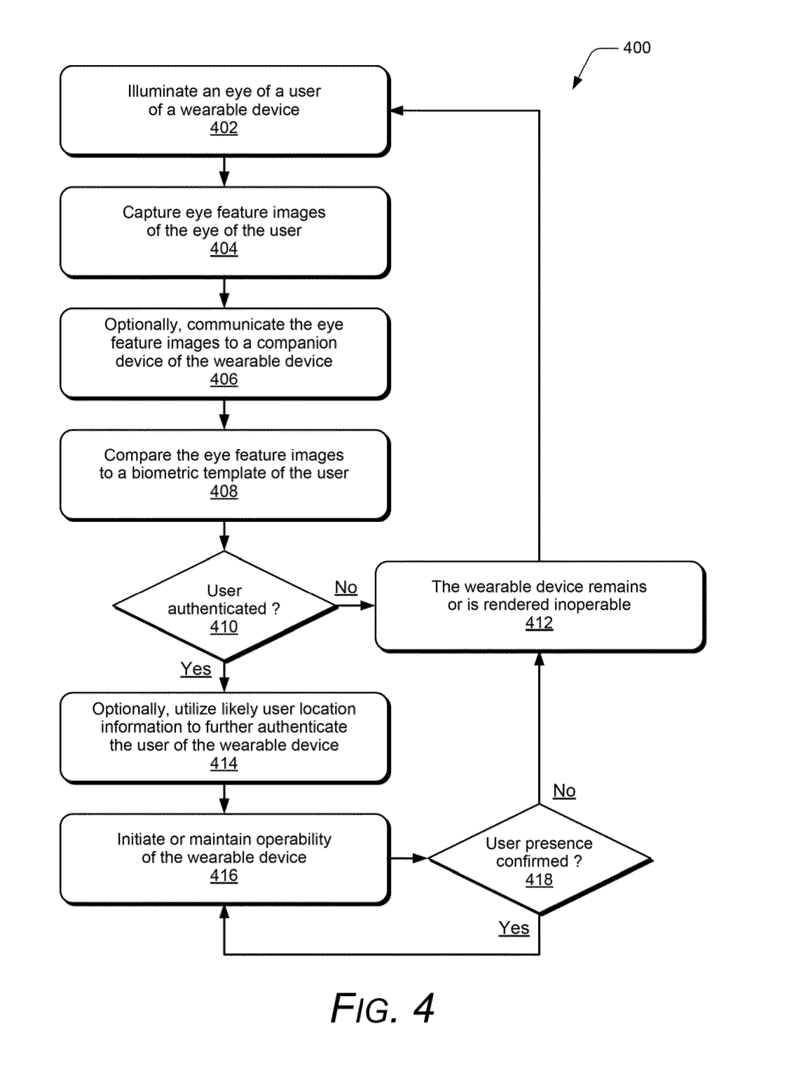

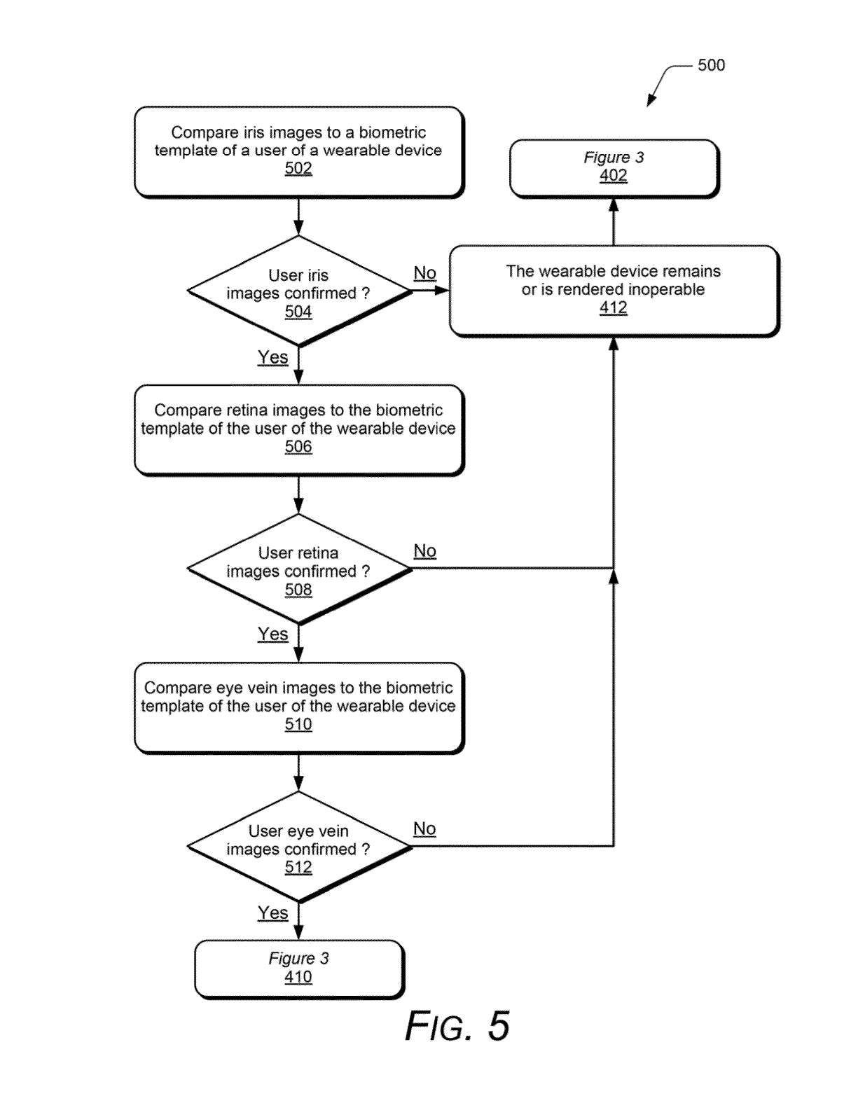

Example methods 400 and 500 are described with reference to FIGS. 4 and 5 in accordance with implementations of wearable device user authentication. Generally, any of the services, components, modules, methods, and operations described herein can be implemented using software, firmware, hardware (e.g., fixed logic circuitry), manual processing, or any combination thereof. The example methods may be described in the general context of executable instructions stored on computer-readable storage media that is local and/or remote to a computer processing system, and implementations can include software applications, programs, functions, and the like.

FIG. 4 illustrates example method(s) 400 of wearable device user authentication, and is generally described with reference to a glasses device that a user wears. The order in which the method is described is not intended to be construed as a limitation, and any number or combination of the described method operations can be performed in any order to perform a method, or an alternate method.

At 402, an eye of a user of a wearable device is illuminated. For example, the glasses device 104 (FIG. 1) includes an infernal light source that illuminates the display lens 122, and incidentally illuminates an eye of the user when the display lens is illuminated, which facilitates capturing the eye feature images 110 of the eye. Similarly, the glasses device 200 (FIG. 2) includes an infra-red light source 224 that illuminates the eye of the user. The infra-red light source can be positioned to directly illuminate an eye of the user, or may be implemented to illuminate the display lens 210 of the glasses device, which incidentally illuminates the eye of the user when the display lens is illuminated.

At 404, eye feature images of the eye of the user are captured. For example, the one or more imagers 108 of the wearable device 102 capture the eye feature images 110 of one or both eyes of a user of the wearable device. The eye feature images of an eye can be captured as any one or combination of iris images, retina images, and/or eye vein images of the eyes of the user. The glasses device 104 includes the imager 112 that can be used to capture the eye feature images 110 with the glasses device held facing towards the eye of the user, such as when the user takes the glasses device off and holds it to position the imager 112 facing an eye of the user to capture the eye feature images. Alternatively, the display lens 122 of the glasses device 104 is implemented with a prism structure 124 that reflects the eye features of an eye of the user to the imager 112 while the user is wearing the glasses device. Alternatively, the glasses device 200 includes the imager 204 that captures the eye feature images of an eye of the user while wearing the glasses device. Additionally, multiple imagers can be implemented as shown and described with reference to FIG. 3 to each capture a portion of either a left eye or a right eye of the user while wearing the wearable device.

At 406, optionally, the eye feature images are communicated to a companion device of the wearable device. For example, the data exchange system 128 of the wearable device 102 communicates the eye feature images 130, the presence data 134 (as detected by the presence sensor 118), and a unique device identifier 136 of the wearable device 102 to the companion device 106.

At 408, the eye feature images are compared to a biometric template of the user. For example, the authentication module 114 implemented at the wearable device 102 compares the eye feature images 110 to the biometric template 116 of the user to authenticate the user of the wearable device. Alternatively, the companion device 106 can implement the authentication module and compare the eye feature images 130 that are received from the wearable device 102 to the biometric template 132 of the user.

At 410, a determination is made as to whether the user is authenticated to use the wearable device based on the comparison. For example, the authentication module 114 implemented at the wearable device 102 authenticates the user based on each of the iris images, the retina images, and the eye vein images both individually and in combination. Comparing the eye feature images to the biometric template (at 408) and determining whether the user is authenticated to use the wearable device (at 410) is further described with reference to the method 500 (FIG. 5).

If the user is not authenticated (i.e., “no” from 410), then the wearable device remains inoperable at 412, and the method continues to illuminate an eye of the user of the wearable device (at 402) and capture the eye feature images of the eye of the user (at 404), if the user is wearing the wearable device. If the user is authenticated (i.e., “yes” from 410), then at 414, likely user location information is optionally utilized to further authenticate the user of the wearable device. For example, the authentication module 114 implemented at the wearable device 102 can optionally enhance the authentication of the user for some higher security applications by incorporating other information about the user, such as a location of the user, a route taken by the user, calendar information, and the like. If the current location of the wearable device (and user) is recognized as a likely location of the user, is a location along a likely route of the user, or is a location identified in a calendar appointment, then authentication may be further confirmed.

At 416, operability of the wearable device is initiated or maintained For example, the wearable device 102, such as the glasses device 104 or the glasses device 200, is initiated for operability if the user of the device is authenticated. At 418, a determination is made as to whether user presence is confirmed. For example, the authentication module 114 implemented at the wearable device 102 can initiate the one or more imagers 108 to periodically capture the eye feature images 110 for comparison to the biometric template 116 to confirm continued user presence and to maintain operability of the device.

The wearable device 102 may also include the presence sensor 118 that periodically detects a presence of the user wearing the wearable device, such as a capacitive sensor that detects user presence based on continued contact with a glasses device while the user is wearing the glasses, or ultrasonic and/or infra-red sensors that periodically detect a biometric indication of user presence. The presence detection is implemented to ensure continuous use by an authenticated user, and as such, the sampling period to confirm user presence is at a fast enough rate to detect if the wearable device is removed from the authenticated user and before it can be re-positioned for use by another person. Additionally, the presence detection can be utilized to conserve device power by initiating a sleep mode or power-off mode when detecting that the wearable device has been removed from the authenticated user.

If user presence is not confirmed (i.e., “no” from 418), then the wearable device is rendered inoperable at 412, and the method continues to illuminate an eye of the user of the wearable device (at 402) and capture the eye feature images of the eye of the user (at 404), if the user is wearing the wearable device. If user presence is confirmed (i.e., “yes” from 418), then the method continues to maintain operability of the wearable device (at 416).

FIG. 5 illustrates other example method(s) 500 of wearable device user authentication, and is generally described with reference to a glasses device that a user wears. The order in which the method is described is not intended to be construed as a limitation, and any number or combination of the described method operations can be performed in any order to perform a method, or an alternate method.

At 502, iris images of an eye of a user are compared to a biometric template of a user-owner of a wearable device. For example, the one or more imagers 108 of the wearable device 102 capture the eye feature images 110 of one or both eyes of a user of the wearable device, and the eye feature images of an eye can include iris images, retina images, and/or eye vein images of the eyes of the user. The authentication module 114 implemented at the wearable device 102 compares the iris images to the biometric template 116 of the user to authenticate the user of the wearable device.

At 504, a determination is made as to whether the iris images of the eye of the user are confirmed based on the comparison to the biometric template of the user-owner. If the iris images of the eye are not confirmed as the user-owner of the wearable device (i.e., “no” from 504), then the wearable device remains inoperable at 412 (FIG. 4), and the method continues to illuminate an eye of the user of the wearable device (at 402) and capture the eye feature images of the eye of the user (at 404), as described with reference to FIG. 4 if the user is wearing the wearable device.

If the iris images of the eye are confirmed as the user-owner of the wearable device (i.e., “yes” from 504), then at 506, retina images of the eye of the user are compared to the biometric template of the user-owner of the wearable device. For example, the authentication module 114 implemented at the wearable device 102 compares the retina images to the biometric template 116 of the user to authenticate the user of the wearable device.

At 508, a determination is made as to whether the retina images of the eye of the user are confirmed based on the comparison to the biometric template of the user-owner. If the retina images of the eye are not confirmed as the user-owner of the wearable device (i.e., “no” from 508), then the wearable device remains inoperable at 412 (FIG. 4). If the retina images of the eye are confirmed as the user-owner of the wearable device (i.e., “yes” from 508), then at 510, eye vein images of the eye of the user are compared to the biometric template of the user-owner of the wearable device. For example, the authentication module 114 implemented at the wearable device 102 compares the eye vein images to the biometric template 116 of the user to authenticate the user of the wearable device.

At 512, a determination is made as to whether the eye vein images of the eye of the user are confirmed based on the comparison to the biometric template of the user-owner. If the eye vein images of the eye are not confirmed as the user-owner of the wearable device (i.e., “no” from 512), then the wearable device remains inoperable at 412 (FIG. 4). If the eye vein images of the eye are confirmed as the user-owner of the wearable device (i.e., “yes” from 512), then the user is authenticated at 410 (FIG. 4) as the user-owner of the wearable device.

FIG. 6 illustrates various components of an example device 600 that can be implemented as any wearable device or companion device described with reference to any of the previous FIGS. 1-5. In embodiments, the example device may be implemented in any form of a companion device that is associated with wearable device, and as a device that receives device data from the wearable device to authenticate a user of the wearable device. For example, a companion device may be any one or combination of a communication, computer, playback, gaming, entertainment, mobile phone, and/or tablet computing device.

The device 600 includes communication transceivers 602 that enable wired and/or wireless communication of device data 604, such as the eye feature images, presence sensor data, and/or other wearable device data. Example transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular telephony, wireless metropolitan area network (WMAN) radios compliant with various IEEE 802.15 (WiMAX™) standards, and wired local area network (LAN) Ethernet transceivers, as well as RFID and/or NFC transceivers.

The device 600 may also include one or more data input ports 606 via which any type of data, media content, and/or inputs can be received, such as user-selectable inputs, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to components, peripherals, or accessories such as microphones and/or cameras.

The device 600 includes a processor system 60S of one or more processors (e.g., any of microprocessors, controllers, and the like) and/or a processor and memory system, (e.g., implemented in an SoC) that processes computer-executable instructions. The processor system may be implemented at least partially in hardware, which can include components of an Integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 610. Although not shown, the device can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The device 600 also includes one or more memory devices 612 that enable data storage, examples of which include random access memory (RAM), non-volatile memory (e.g., read-only memory (ROM), flash memory, EPROM, EEPROM, etc.), and a disk storage device. A disk storage device may be implemented as any type of magnetic or optical storage device, such as a hard disk drive, a recordable and/or rewritable disc, any type of a digital versatile disc (DVD), and the like. The device 600 may also include a mass storage media device.

A memory device 612 provides data storage mechanisms to store the device data 604, other types of information and/or data, and various device applications 614 (e.g., software applications). For example, an operating system 616 can be maintained as software instructions with a memory device and executed by the processor system 608. The device applications may also include a device manager, such as any form of a control application, software application, signal-processing and control module, code that is native to a particular device, a hardware abstraction layer for a particular device, and so on. The device may also include an authentication module 618 that authenticates a user of a wearable device, such as when the device 600 is implemented as a wearable device (e.g., a glasses device) or as a companion device of a wearable device as described with reference to FIGS. 1-5.

The device 600 also includes an audio and/or video processing system 620 that generates audio data for an audio system 622 and/or generates display data for a display system 624. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 626. In implementations, the audio system and/or the display system are integrated components of the example device, which may also include wireless video and/or audio technologies.

The device 600 can also include a power source 628, such as when the device is implemented as a wearable device (e.g., a glasses device). The power source may include a charging and/or power system, and can be implemented as a flexible strip battery, a rechargeable battery, a charged super-capacitor, and/or any other type of active or passive power source.

Although embodiments of wearable device user authentication have been described in language specific to features and/or methods, the subject of the appended claims is not necessarily limited to the specific features or methods described. Rather, the specific features and methods are disclosed as example implementations of wearable device user authentication.

1. A wearable device, comprising:
an imager configured to capture one or more eye feature images of an eye of a user of the wearable device;
a processing system to implement an authentication module configured to:
authenticate the user based on a comparison of the one or more eye feature images to a biometric template of the user; and
periodically initiate the imager to capture the one or more eye feature images to confirm user presence and maintain operability of the wearable device.

2. The wearable device as recited in claim 1, wherein the imager is configured to capture the one or more eye feature images of the eye of the user while wearing the wearable device.

3. The wearable device as recited in claim 1, further comprising a display lens configured to display a viewable image, wherein:
the display lens is configured to display the viewable image as a viewing target on the display lens to position the eye of the user to facilitate the imager capturing an eye feature image of a first side of the eye; and
the display lens is configured to display the viewing target shifted on the display lens to position the eye of the user to facilitate the imager capturing another eye feature image of a second side of the eye.

4. The wearable device as recited in claim 1, wherein the imager is configured to capture the one or more eye feature images of a portion of the eye of the user.

5. The wearable device as recited in claim 4, further comprising:
an additional imager configured to capture the one or more eye feature images of a different portion of the eye of the user.

6. The wearable device as recited in claim 1, further comprising: multiple imagers each configured to capture a portion of either a left eye or a right eye of the user while wearing the wearable device.

7. The wearable device as recited in claim 1, wherein:
the imager is implemented in the wearable device further configured to capture forward-facing images of an environment viewed by the user wearing the wearable device; and
die imager is configured to capture the one or more eye feature images with the wearable device held facing towards the eye of the user.

8. The wearable device as recited in claim 1, further comprising:
a display lens configured to display an image for user viewing, the display lens including a prism structure configured to reflect eye features of the eye of the user to the imager.

9. The wearable device as recited in claim 8, further comprising:
a light source configured to illuminate the display lens, the light source further configured to illuminate the eye of the user to facilitate the one or more eye feature images being captured with the imager.

10. The wearable device as recited in claim 1, wherein the one or more eye feature images include at least one of iris images, retina images, and eye vein images of the eye of the user.

11. The wearable device as recited in claim 10, wherein the authentication module is configured to authenticate the user based on each of the iris images, the retina images, and the eye vein images both individually and in combination.

12. The wearable device as recited in claim 1, further comprising;
an infra-red light source configured to illuminate the eye of the user; and
wherein the authentication module is configured to initiate the infra-red light source to illuminate the eye of the user to facilitate the one or more eye feature images being captured.

13. The wearable device as recited in claim 1, wherein the authentication module is configured to use likely user location information to further authenticate the user of the wearable device.

14. The wearable device as recited in claim 1, further comprising:
a data exchange system configured to communicate the one or more eye feature images to a companion device of the wearable device, the companion device configured to compare the one or more eye feature images to the biometric template of the user to said authenticate the user.

15. The wearable device as recited in claim 1, further comprising:
a presence sensor configured to periodically detect the user who wears the wearable device, the presence sensor comprising one of:
a capacitive sensor configured to detect the user based on continued contact with the wearable device;
an ultrasonic sensor configured to detect user wellness or presence feedback; or
an infra-red (IR) sensor configured to detect the user wellness or presence feedback.

16. A method, comprising:
capturing one or more eye feature images of an eye of a user of a wearable device;
comparing the one or more eye feature images to a biometric template of the user;
authenticating the user to use the wearable device based on the comparison;
initiating an imager to periodically capture the one or more eye feature images for said comparing to confirm user presence; and
confirming the user presence to maintain operability of the wearable device.

17. The method as recited in claim 16, further comprising:
reflecting eye features of the eye of the user to the imager with a prism structure of a display fens that is configured to display an image for user viewing, the imager said capturing the one or more eye feature images from the reflected eye features.

18. The method as recited in claim 16, further comprising: illuminating the eye of the user to facilitate said capturing the one or more eye feature images.

19. The method as recited in claim 16, wherein;
the one or more eye feature images include at least one of iris images, retina images, and eye vein images of the eye of the user; and
said authenticating the user based, on each of the iris images, the retina images, and the eye vein images both individually and in combination.

20. The method as recited in claim 16, wherein said capturing the one or more eye feature images of the eye of the user comprises:
displaying a viewing target on a display lens of the wearable device to position the eye of the user to capture an eye feature image of a first side of the eye; and
shifting the viewing target on the display lens to position the eye of the user to capture another eye feature image of a second side of the eye.

21. The method as recited in claim 16, further comprising:
utilizing likely user location information to further authenticate the user of the wearable device.

22. The method as recited in claim 16, further comprising:
communicating the one or more eye feature images to a companion device of the wearable device, the companion device said comparing the one or more eye feature images to the biometric template of the user.

23. A system, comprising:
a wearable device configured to capture eye feature images of a user and periodically detect a presence of the user wearing the wearable device; and
a companion device of the wearable device, the companion device configured to compare the eye feature images to a biometric template of the user and authenticate the user to use the wearable device based on the comparison.

24. The system as recited in claim 23, wherein the wearable device is configured to periodically capture the eye feature images of the user for comparison to the biometric template of the user and to confirm user presence and maintain operability of the wearable device.

25. The system as recited in claim 23, wherein the wearable device is configured to capture fee eye feature images of the user while wearing the wearable device.
